(19) United States
(12) Patent Application Publication
(10) Pub. No.: US 2018/0145490 A1
(43) Pub. Date: May 24, 2018

(54) APPARATUS FOR SUPPORTING CONDUITS AND CHANNEL MEMBERS

(71) Applicants: Scott W. Guinta, Sherman, CT (US); Thomas J. Myhal, Montebello, NY (US)

(72) Inventors: Scott W. Guinta, Sherman, CT (US); Thomas J. Myhal, Montebello, NY (US)

(21) Appl. No.: 15/357,853

(22) Filed: Nov. 21, 2016

(51) Int. Cl. H02G 3/04; F16L 3/12; F16L 3/22; F16L 5/00; H02G 3/22

(52) U.S. Cl. CPC H02G 3/0481; F16L 3/1215; H02G 3/22; F16L 5/00; F16L 3/221

(57) ABSTRACT

An apparatus is described for supporting a conduit. The apparatus includes a plate portion, a clamp portion, and an attachment fastener. The plate portion includes a flat plate, as well as a tongue projecting from an edge of the flat plate and defining a tongue attachment hole. The clamp portion includes a base that contains a clamp attachment hole, a pair of opposed legs extending from the base and defining a void between them, and a clamp fastener spanning between the pair of opposed legs. The attachment fastener passes through the tongue attachment hole and the clamp attachment hole so as to fixate the clamp portion to the plate portion.

### FIELD OF THE INVENTION

The present invention relates generally to support elements for use in structures, and, more particularly, to apparatus for mounting and supporting building elements such as electrical conduits, plumbing, channel members, and the like.

### BACKGROUND OF THE INVENTION

Electrical conduits are frequently used to route electrical wiring in modern buildings. An electrical conduit is typically formed of metal, plastic, fiber, or clay. Most are rigid, but flexible electrical conduits are also utilized in some applications.

Routing and supporting electrical wires with electrical conduits provides several advantages. For example, electrical conduits provide protection to the enclosed wires from impact, moisture, and chemicals. Electrical conduits also facilitate modifying the enclosed wiring with little disruption to nearby structures. When properly sealed with fireproof material, an electrical conduit will not permit the flow of flammable gases, which may inhibit the spread of fire.

Electrical conduits will variously be hung from building structures and made to penetrate walls, floors, and ceilings. While some hardware already exists for supporting electrical conduits, little of that hardware is particularly well suited for supporting electrical conduits where they actually penetrate building structures. As a result, there is a need for specially designed brackets that aid in mounting electrical conduits at these points of penetration.

### SUMMARY OF THE INVENTION

Embodiments of the present invention provide bracket assemblies that support both conduits and channel members.

Aspects of the invention are directed to an apparatus comprising a plate portion, a clamp portion, and an attachment fastener. The plate portion defines a flat plate, as well as a tongue projecting from an edge of the flat plate and defining a tongue attachment hole passing therethrough. The clamp portion defines a base that defines a clamp attachment hole passing therethrough, a pair of opposed legs extending from the base and defining a void therebetween, and a clamp fastener spanning between the pair of opposed legs. The attachment fastener passes through the tongue attachment hole and the clamp attachment hole so as to fixate the clamp portion to the plate portion.

Additional aspects of the invention are directed to an apparatus comprising a plate portion and a channel member. The plate portion defines a flat plate, as well as a tongue projecting from an edge of the flat plate and defining a tongue attachment hole passing therethrough. An attachment fastener passes through the tongue attachment hole and the channel member so as to fixate the channel member to the plate portion.

Additional aspects of the invention are directed to a method of supporting a conduit. A plate portion and a clamp portion are received. The plate portion defines a flat plate, as well as a tongue projecting from an edge of the flat plate and defining a tongue attachment hole passing therethrough. The clamp portion defines a base that defines a clamp attachment hole passing therethrough, a pair of opposed legs extending from the base and defining a void therebetween, and a clamp fastener spanning between the pair of opposed legs. The plate portion is fixated to the clamp portion via an attachment fastener passing through the tongue attachment hole and the clamp attachment hole. The plate portion is fixated to a structure of a building. Finally, the conduit is captured by the clamp portion.

Even additional aspects of the invention are directed to a method of supporting a channel member. A plate portion and a channel member are received. The plate portion defines a flat plate, as well as a tongue projecting from an edge of the flat plate and defining a tongue attachment hole passing therethrough. The channel member is fixated to the plate portion via an attachment fastener passing through the tongue attachment hole and the channel member. The plate portion is fixated to a structure of a building.

### BRIEF DESCRIPTION OF THE DRAWINGS

These and other features, aspects, and advantages of the present invention will become better understood with regard to the following description, appended claims, and accompanying drawings where:

FIG. 1 shows a perspective view of a bracket assembly supporting a conduit as it penetrates a wall, in accordance with an illustrative embodiment of the invention;

FIG. 2 shows a exploded perspective view of the FIG. 1 bracket assembly;

FIG. 3 shows a perspective view the FIG. 1 bracket assembly attached to a cinder block;

FIG. 4 shows a perspective view of a bracket assembly in accordance with a first alternative embodiment of the invention; and

FIG. 5 shows an exploded perspective view of a bracket assembly in accordance with a second alternative embodiment of the invention.

### DETAILED DESCRIPTION OF THE INVENTION

The present invention will be described with reference to illustrative embodiments. For this reason, numerous modifications can be made to these embodiments and the results will still come within the scope of the invention. No limitations with respect to the specific embodiments described herein are intended or should be inferred.

As used in the present specification and accompanying claims, the term “flat plate” is intended to mean a plate that is flat within regular and reasonable manufacturing tolerances for brackets used in the building trade. “Substantially normal” means within ten degrees of perpendicular. A “conduit” incorporates any object shaped in the form of a pipe, duct, or tube. A conduit may carry electrical wiring, or may convey gases or liquids. Lastly, a “fastener” is intended to encompass both bolts and screws.

Apparatus in accordance with aspects of the invention provide a means for supporting conduits in building structures. Such apparatus are particularly well suited for supporting conduits where they approach and penetrate a building structure such as a wall, floor, or ceiling at a ninety degree angle.

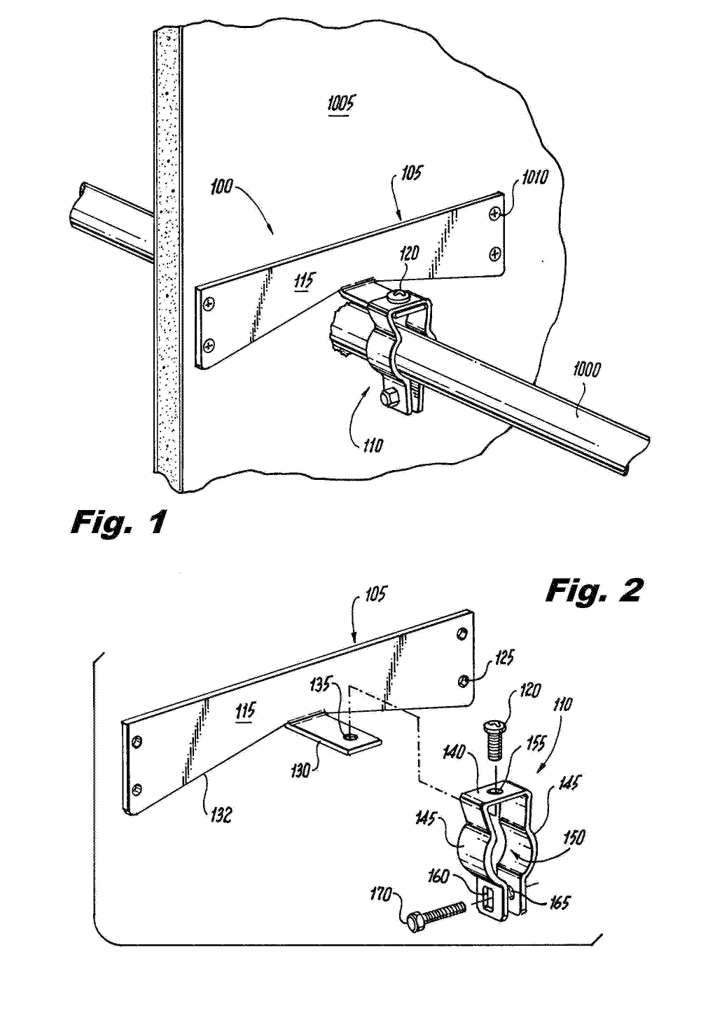

An example of an apparatus falling within the scope of the invention is shown in perspective in FIG. 1. FIG. 1 shows a bracket assembly 100 supporting an electrical conduit 1000 where the electrical conduit 1000 penetrates a wall 1005. The bracket assembly 100 may be conceptually reduced to two main portions: a plate portion 105 and a clamp portion 110. The plate portion 105 defines a flat plate 115 that is attached to the wall 1005 via four fixation fasteners 1010. The clamp portion 110 captures the electrical conduit 1000, and is fixated to the plate portion 105 via an attachment fastener 120 that passes through both portions 105, 110.

More details of the plate portion 105 and the clamp portion 110, as well as the manner in which they interact, is provided by an exploded perspective view in FIG. 2. In addition to the flat plate 115, the plate portion 105 further defines four fixation holes 125 that accommodate the four fixation fasteners 1010, and a tongue 130 that projects from an edge 132 of the flat plate 115. The tongue 130 is oriented substantially normal to the flat plate 115 and has a thickness about equal to that of the flat plate 115. The tongue 130 defines a tongue attachment hole 135 passing therethrough. The tongue attachment hole 135 is internally threaded.

The clamp portion 110 defines a base 140 with a pair of opposed legs 145 that extend from the base 140 to define a void 150 therebetween. The void 150 is dimensioned to capture the conduit 1000. The base 140 defines a clamp attachment hole 155 passing therethrough. At the same time, one of the legs 145 defines a slot 160, while the other defines a receiving hole 165 positioned in opposed relation to the slot 160. The receiving hole 165 is internally threaded. A clamp fastener 170 passes through the slot 160 and is threaded into the receiving hole 165 so as to span between the pair of opposed legs 145. The clamp fastener 170 may be rotated in one direction to cause the pair of opposed legs 145 to be urged towards each other, and rotated in the other to allow the pair of opposed legs 145 to relax away from each other.

With the parts constructed as indicated in FIG. 2, the condition shown in FIG. 1 may be achieved by initially fixating the plate portion 105 to the face of the wall 1005 using the fixation holes 125 in the flat plate 115 and the four fixation fasteners 1010. The flat plate 115 is located immediately above where the conduit 1000 is intended to penetrate the wall 1005 with the tongue 130 directed away from the wall 1005. Subsequently, the clamp portion 110 may be attached to the plate portion 105 by simply resting the base 140 on the tongue 130 such that the tongue 130 is placed between the pair of opposed legs 145 with the clamp attachment hole 155 (unthreaded) aligned with the tongue attachment hole 135 (threaded). The attachment fastener 120 is then passed through both holes 135, 155 with the attachment fastener 120 threadably engaged with the internal threads of the tongue attachment hole 135. The attachment fastener 120 may be tightened to complete fixating the clamp portion 110 to the plate portion 105. The conduit 1000 may then be placed through the wall 1005 and into the void 150 between the legs 145 of the clamp portion 110. The clamp fastener 170 is next rotated so that the legs 145 tighten down on the outside of the conduit 1000 to cause the conduit 1000 to be firmly captured by the bracket assembly 100. Of course, the above-identified steps may also be performed in a different order, and the results would still come within the scope of the invention.

To keep the clamp portion 110 from rotating relative to the plate portion 105, the tongue 130 preferably (but not necessarily) has a width about equal to the space between the pair of opposed legs 145 of the clamp portion 110 (see FIG. 1). The contact between the opposed edges of the tongue 130 and the insides of the pair of opposed legs 145 inhibits this relative motion.

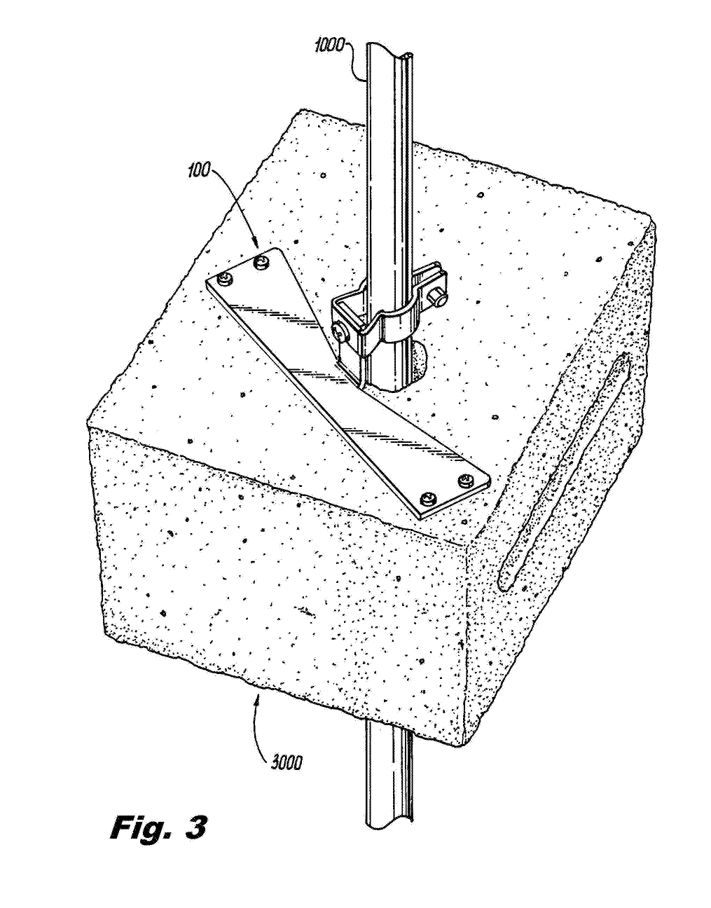

The bracket assembly 100 may be mounted to essentially any building structure with a reasonably flat face. The bracket assembly 100 may, for example, be mounted to a panel of sheetrock, to a cinderblock or cement structure, and to metal or wood framing or beams. The bracket assembly 100 supporting the conduit 1000 and mounted to a cinderblock 3000, for example, is shown in a perspective view in FIG. 3. The same bracket assembly 100, moreover, may be utilized to support a conduit that penetrates a floor or ceiling structure rather than a wall structure. The bracket assembly 100, and, more generally, apparatus in accordance with aspects of the invention, may therefore be used in many different applications from electrical wiring to plumbing and heating/cooling. In some applications, for instance, the bracket assembly 100 may be used to support electrical conduits, while in others, it may be used to support conduits that carry gases or liquids.

The bracket assembly 100 may be formed of any one of several materials, including, but not limited to, metal and plastic. The bracket assembly 100 may for example, be formed of steel. The tongue 130 and the flat plate 115 of the plate portion 105 may be formed of a single unitary piece of material without a joint or seam therebetween. Having the entire plate portion 105 formed of a unitary piece of materials aids both ease-of-manufacture and strength. The plate portion 105 may initially be cut from a flat sheet of metal stock. Subsequently, the fixation holes 125 in the flat plate 115 and the tongue attachment hole 135 may be formed in the tongue 130, and then the tongue 130 bent away from the remainder of the plate portion 105 to achieve the plate portion 105 described above. These various metal forming steps are well within the skills of one having ordinary skill in the relevant arts.

The clamp portion 110 may be sourced commercially and are readily available from several sources. As just one example, MINERALLAC® Company (Hampshire, Ill., USA) sells steel conduit hangers which would be suitable for use as the clamp portion 110 in the bracket assembly 100.

It will be noted that the edge 132 of the flat plate 115 from which the tongue 130 projects has an angled shape that causes the flat plate 115 to have a narrower width at its center than at its sides, where the four fixation holes 125 are placed. This causes the tongue 130 to be centered between the four fixation holes 125. Having the tongue 130 centered in this manner helps to evenly distribute any weight carried by the tongue 130 on the four fixation fasteners 1010. It also provides additional room for the conduit 1000 to pass under the tongue 130. The unique shape also allows the fixation holes 125 in the flat plate 115 to be sufficiently spaced apart to avoid having them place undue stress on the surface to which the flat plate 115 is fixated.

The bracket assembly 100 has several advantages. For example, its components are relatively simple to manufacture and source, and are relatively inexpensive. The bracket assembly 100 may also be readily installed by a single installer without assistance from others. Just a single bracket assembly 100 is able to more than adequately support a conduit and its contents as the conduit penetrates a wall, floor, ceiling, or other structure.

Actual prototypes of the bracket assembly 100 readily supported the weight of several differently sized conduits. The prototype plate portions were formed of steel and had thicknesses of about 1.8 mm. Heights were about 5.3 cm and widths were about 20 cm, with height being the vertical direction and width being the horizontal direction with the prototype plate portions oriented in the manner of the plate portion 105 in FIGS. 1 and 2. The prototype tongues had lengths of about 5.2 cm and widths of about 1.7 cm. Conduits captured by the prototype bracket assemblies were firmly held in place and resisted movement in any direction, including longitudinally.

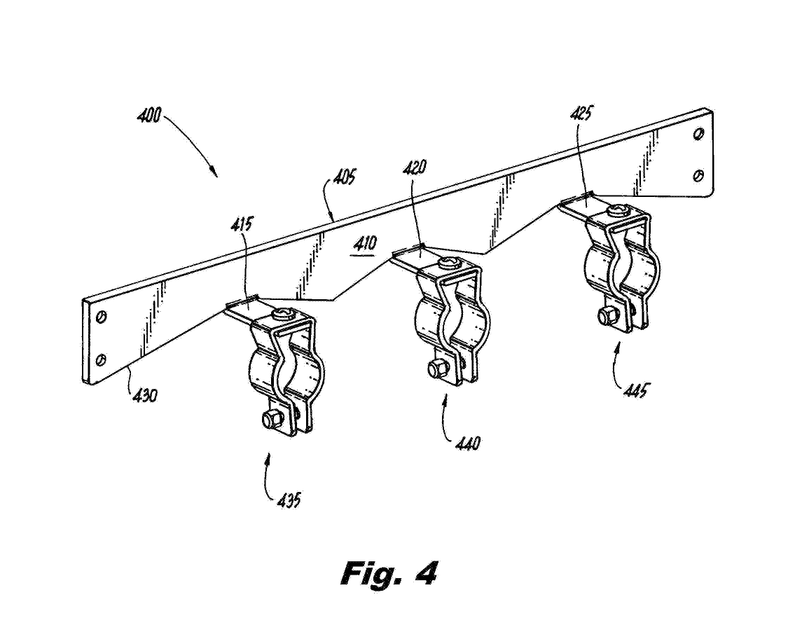

FIG. 4 shows a perspective view of a first alternative bracket assembly 400, in accordance with another illustrative embodiment of the invention. The first alternative bracket assembly 400 includes a plate portion 405 defining a flat plate 410 with three tongues 415, 420, 425 projecting from an edge 430 of the flat plate. Each tongue 415, 420, 425 supports a respective clamp portion 435, 440, 445. A first clamp portion 435 is fixated to a first tongue 415, while a second clamp portion 440 is fixated to the second tongue 420. The third clamp portion 445 is fixated to the third tongue 425. While the first alternative bracket assembly 400 supports three clamp portions, this number is merely illustrative. In other alternative embodiments falling within the scope of the invention, a single plate portion may instead support any number of clamp portions (e.g., 2, 4, 5, 6, and so on).

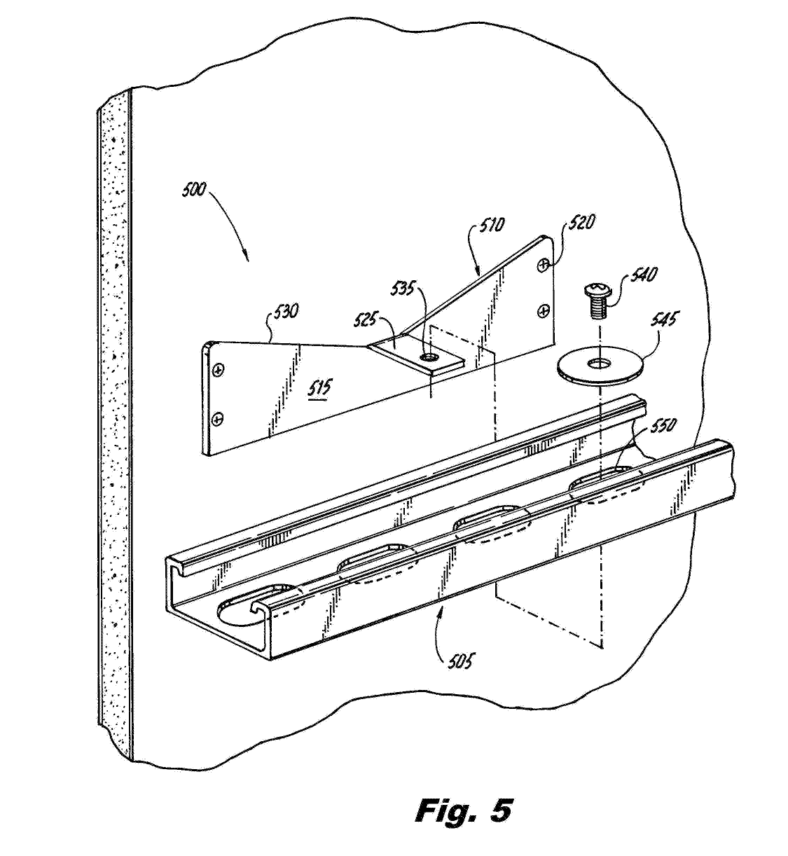

FIG. 5 shows an exploded perspective view of a second alternative bracket assembly 500, in accordance with even another illustrative embodiment of the invention. Rather than supporting a conduit via a clamp member, the bracket assembly 500 includes a channel member 505. The channel member 505 may support any number of other elements, including conduits, air conditioning equipment, ventilation equipment, and the like. In this particular illustrative embodiment, the channel member 505 comprises what is frequently called a “strut channel.” Such channel members are available commercially from a number of different vendors, including, for example, FASTENAL® Company (Winona, Minn., USA).

A plate portion 510 in the bracket assembly 500 is essentially identical to that in the bracket assembly 100, reinforcing the fact that a single plate portion design may be used in several different applications (i.e., the single plate portion design is universal to several different applications). The plate portion 510 defines a flat plate 515 with fixation holes 520. A tongue 525 projects from an edge 530 of the flat plate 515 and defines a threaded attachment hole 535 passing therethrough.

The channel member 505 is attached to the plate portion 510 by passing an attachment fastener 540 through a washer 545 and then through an opening 550 in the channel member 505. The attachment fastener 540 is then threaded into the threaded attachment hole 535 of the tongue 525 to fixate the channel member 505 to the plate portion 510. The bracket assembly 500 may be mounted with the channel member 505 resting on top of the tongue 525, as shown in FIG. 5, or may instead be mounted such that the channel member 505 is suspended from the tongue 525 (as would be the case if FIG. 5 were rotated 180 degrees).

It should again be emphasized that the above-described embodiments of the invention are intended to be illustrative only. Other embodiments can use different types and arrangements of elements for implementing the described functionality. These numerous alternative embodiments within the scope of the appended claims will be apparent to one skilled in the art.

For example, some of the fixations in the above-described assemblies rely on one hole being unthreaded and a corresponding hole being threaded. Alternative embodiments may reverse these configurations. In addition, while some of the fixations rely on threaded holes to threadably engage a fastener, one skilled in the relevant arts will also realize from the description provided herein that such threaded holes may in most circumstances be made unthreaded, and a nut used in combination with a fastener to provide the fixation.

All the features disclosed herein may be replaced by alternative features serving the same, equivalent, or similar purposes, unless expressly stated otherwise. Thus, unless expressly stated otherwise, each feature disclosed is one example only of a generic series of equivalent or similar features.

Any element in a claim that does not explicitly state “means for” performing a specified function or “step for” performing a specified function is not to be interpreted as a “means for” or “step for” clause as specified in AIA 35 U.S.C. § 112(f). In particular, the use of “steps of” in the claims herein is not intended to invoke the provisions of AIA 35 U.S.C. § 112(f).

What is claimed is:

1. An apparatus comprising:
a plate portion defining:
a flat plate; and
a tongue projecting from an edge of the flat plate and defining a tongue attachment hole passing therethrough.

2. The apparatus of claim 1, wherein the flat plate defines a plurality of fixation holes passing therethrough.

3. The apparatus of claim 1, wherein the tongue is substantially normal to the flat plate.

4. The apparatus of claim 1, wherein the tongue and the flat plate are formed of a unitary piece of material without a joint or seam therebetween.

5. The apparatus of claim 1, wherein the tongue attachment hole is internally threaded.

6. The apparatus of claim 1, further comprising:
a clamp portion defining:
a base defining a clamp attachment hole passing therethrough;
a pair of opposed legs extending from the base and defining a void therebetween; and
a clamp fastener spanning between the pair of opposed legs; and
an attachment fastener passing through the tongue attachment hole and the clamp attachment hole so as to fixate the clamp portion to the plate portion.

7. The apparatus of claim 6, wherein the clamp fastener may be rotated to urge the pair of opposed legs towards each other.

8. The apparatus of claim 6, wherein the clamp portion is operative to capture a conduit in the void.

9. The apparatus of claim 6, further comprising:
a second tongue projecting from the edge of the flat plate; and
a second clamp portion fixated to the second tongue.

10. The apparatus of claim 9, further comprising:
a third tongue projecting from the edge of the flat plate; and
a third clamp portion fixated to the third tongue.

11. The apparatus of claim 1, further comprising:
a channel member; and
an attachment fastener passing through the tongue attachment hole and the channel member so as to fixate the channel member to the plate portion.

12. The apparatus of claim 11, wherein the channel member comprises a strut channel.

13. The apparatus of claim 11, further comprising a washer, wherein the attachment fastener passes through the washer.

14. A method comprising the steps of:
receiving a plate portion defining:
a flat plate; and
a tongue projecting from an edge of the flat plate and defining a tongue attachment hole passing therethrough;
receiving a clamp portion defining:
a base defining a clamp attachment hole passing therethrough;
a pair of opposed legs extending from the base and defining a void therebetween; and
a clamp fastener spanning between the pair of opposed legs;
fixating the clamp portion to the plate portion via an attachment fastener passing through the tongue attachment hole and the clamp attachment hole;
fixating the plate portion to a structure of a building; and
capturing a conduit in the clamp portion.

15. The method of claim 14, wherein the step of fixating the plate portion to the structure of a building comprises passing a fixation fastener through a fixation hole in the flat plate and into the structure.

16. The method of claim 14, wherein the structure is a wall, floor, or ceiling.

17. The method of claim 14, wherein the step of capturing the conduit in the clamp portion comprises rotating the clamp fastener.

18. A method comprising the steps of:
receiving a plate portion defining:
a flat plate; and
a tongue projecting from an edge of the flat plate and defining a tongue attachment hole passing therethrough;
receiving a channel member;
fixating the channel member to the plate portion via an attachment fastener passing through the tongue attachment hole and the channel member; and
fixating the plate portion to a structure of a building.

19. The method of claim 18, wherein the step of fixating the plate portion to the structure of a building comprises passing a fixation fastener through a fixation hole in the flat plate and into the structure.

20. The method of claim 18, wherein the structure is a wall, floor, or ceiling.
